(19) United States
(12) Patent Application Publication
(10) Pub. No.: US 2008/0227054 A1
(43) Pub. Date: Sep. 18, 2008

(54) DENTAL INSTRUMENT

(75) Inventor: Jan-Dirk REIMERS, Aachen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HERAEUS KULZER GMBH, Hanau (DE)

(21) Appl. No.: 12/048,685

(22) Filed: Mar. 14, 2008

(30) Foreign Application Priority Data
Mar. 14, 2007 (DE) 10 2007 12 952.3
May 12, 2007 (DE) 10 2007 022 295.7

(51) Int. Cl. A61C 3/00

(52) U.S. Cl. 433/114

(57) ABSTRACT

An angled dental shaft receptacle is provided for operating rotating instruments with an angled shaft. The angled shaft receptacle has a driver pin, and the driver pin is connected to the angled shaft of the instrument by a planar contact during operation. The rotating instrument is preferably a dental instrument.

### BACKGROUND OF THE INVENTION

Dental instruments of all types, which are provided for use as rotating instruments in an angled piece, also conceivable as an angled shaft receptacle, have a specially shaped shaft, called an angled piece connection or also angled shaft. This connection has been standardized for rotating tools and is manufactured worldwide in specified dimensions and tolerances. It is used equally for tools with high rotational speeds and small torques and with high torques and low rotational speeds, for example drills, enhancers, cutting attachments, thread cutters, counterbores, insertion instruments for implants, etc.

The rotating tools can be set and used with this type of connection, not only in motor-driven angled pieces, but also in manually-activated handles or adapters. The angled shaft is a critical interface for the use of nearly all types of dental tools.

This known convention for the structural shape of the force-transmitting connection on the shaft of the instrument (e.g., a drill) does not take into account the torques that are possible today and that are in some places necessary in dental instrumentation. The counterpiece for the force transmission in the adapter or angled piece is often not in a position for guaranteeing an optimum force transmission. Similarly, it does not take into account modern requirements for higher torques. Mostly, simple metal sheets are stamped for angled pieces, in order to obtain a reverse contour for the angled shaft. These metal sheets are then used as torque drivers and transmit the torque to the shaft via a contact region. For angled pieces in the form of hand adapters or shaft extenders, for the most part, pins are turned with a driver finger, which then similarly transmit the force to the shaft via a contact surface. All of these force-transmitting surfaces are shaped in such a way that a linear contact surface is formed between the two parts.

It has been shown that for high torques, the dental instrument or the angled piece, or both are damaged. The two components can seize or one part of the assembly can be destroyed. This is assisted by a currently used linear contact of the parts, because these are plastically deformed by high forces.

The tolerances between the angled shaft and the driver pin of the angled piece always lead to twisting between the two force-transmitting surfaces. This is bigger or smaller according to the tolerances of the two components and leads to a greater or smaller angle difference of the two force-transmitting surfaces. This leads to the fact that the two surfaces come into contact with each other only in a linear contact at the outer edge of the shaft. This linear contact surface at the outer edge of the angled shaft is plastically deformed according to the calculable rules of Hertzian pressure and forms newly shaped contact surfaces, until the surface pressure formed by the force transmission falls below the plastic deformation limit Rp 0.2. With the torque necessary under some circumstances for supplying implants or the specified tightening of prosthetic screws with a minimum torque prescribed by the manufacturer, force levels are reached which, in the current structural solution of the contact surface, lead to loading significantly above the plastic deformation limit of typical materials for rotating tools. Clear and permanent deformations in the form of bevels and burrs are formed on the outside shaft edge on the force-transmitting surfaces.

From the formation of these deformation surfaces changes in the diameter of the shaft geometry can result, so that the instrument seizes in the angled piece or a damaging reverse coupling to the structure of the angled piece is created. The deformation of the angled shaft can also lead to the functional failure of the connection.

An economically less meaningful path is to reduce the manufacturing tolerances. However, according to current technical solutions, it is the only possibility for minimizing this effect. Furthermore, the use of higher-strength materials with an increased expansion limit can shift the effect of deformation to higher torques. This is likewise a non-economical path in terms of manufacturing, because the production of dental tools in principle becomes more expensive. A structural change is not in line with the market, at least for the shaft connections, due to the decades-long standardization of the angled shaft dimensions. The goal must be to achieve an improvement with changes to the construction of the angled piece and its geometry of the driver pin.

### BRIEF SUMMARY OF THE INVENTION

Therefore, the problem of the invention is to provide an angled shaft receptacle for the operation of dental instruments or an angled shaft in an angled piece or hand adapter, which allows improved transmission of torques.

The angled shaft receptacle of an angled dental piece according to the invention for rotating dental instruments, wherein the angled shaft receptacle has a driver pin, provides that the driver pin and the angled shaft are always connected in the angled shaft receptacle by a planar contact during the operation of the angled piece.

In this way, only the angled shaft receptacle (angled piece) is changed structurally, whereby the prevailing standards for manufacturing dental instruments or their angled shaft geometry are still totally taken into account. The transmission of significantly higher torques is thereby permitted free from damage. The possibilities for using this universal connection system for dental tools is therefore significantly increased and made significantly more reliable in use.

Advantageously, the angled piece is driven by a motor or manually.

An advantageous embodiment of the invention provides that the planar contact, which is formed by the driver of the angled shaft receptacle with the angled shaft and which is necessary for the force transmission, generates only deformations of the contact surfaces in the Hooke's Law range. The deformations of the contact surfaces are thus purely elastic; the material is thus subjected to no plastic deformation.

The planar contact must be constructed in such a way that, for all of the resulting tolerance pairings, a surface is created, which fulfills the criterion:

σ contact surface≦Rp 0.2.

For determining this condition, the principles of Hertzian pressure apply. These principles allow a calculation of various geometric body contacts and allow the surface pressures created in the material to be estimated. A material, which is loaded below the plastic deformation limit, is deformed only reversibly or elastically and assumes its original shape again after loading.

Thus, independent of the manufacturing tolerances, a unit functioning uniformly free from damage can always be provided.

Advantageously, the driver pin has a constant radius at the force-transmitting surface.

In a preferred embodiment, the invention provides that the driver pin has a variable radius at the force-transmitting surface. This variable radius can have a special functional relationship.

It has been shown that it is advantageous if the driver pin has a combination of surfaces and radii of variable type at the force-transmitting surface.

According to the invention, the driver of the angled shaft receptacle (angled piece) should be shaped in such a way that the contact position always consists of the flat surface of the angled shaft and a curved surface of the driver of the receptacle, independent of the tolerances of the components.

Advantageously, a supporting thrust bearing is provided on the side opposite the driver pin.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1a is a side view of an angled shaft according to the prior art;

FIG. 1b is an end view of the angled shaft according to FIG. 1a;

FIG. 2a is an end view of a driver pin in an angled piece (angled shaft receptacle) according to the prior art;

FIG. 2b is a sectional side view of a driver pin in an angled piece (angled shaft receptacle) according to FIG. 2a;

FIGS. 3a and 3b are end views of are end views of connections of the angled shaft and the angled piece with a driver pin according to the prior art;

FIGS. 4a to 4d are end views of a driver pin in an angled piece according to various embodiments of the invention; and

FIGS. 5a and 5b are end views of a connection of the angled shaft and the angled piece with a driver pin according to an embodiment of the invention in unloaded and torsion loaded conditions, respectively.

### DETAILED DESCRIPTION OF THE INVENTION

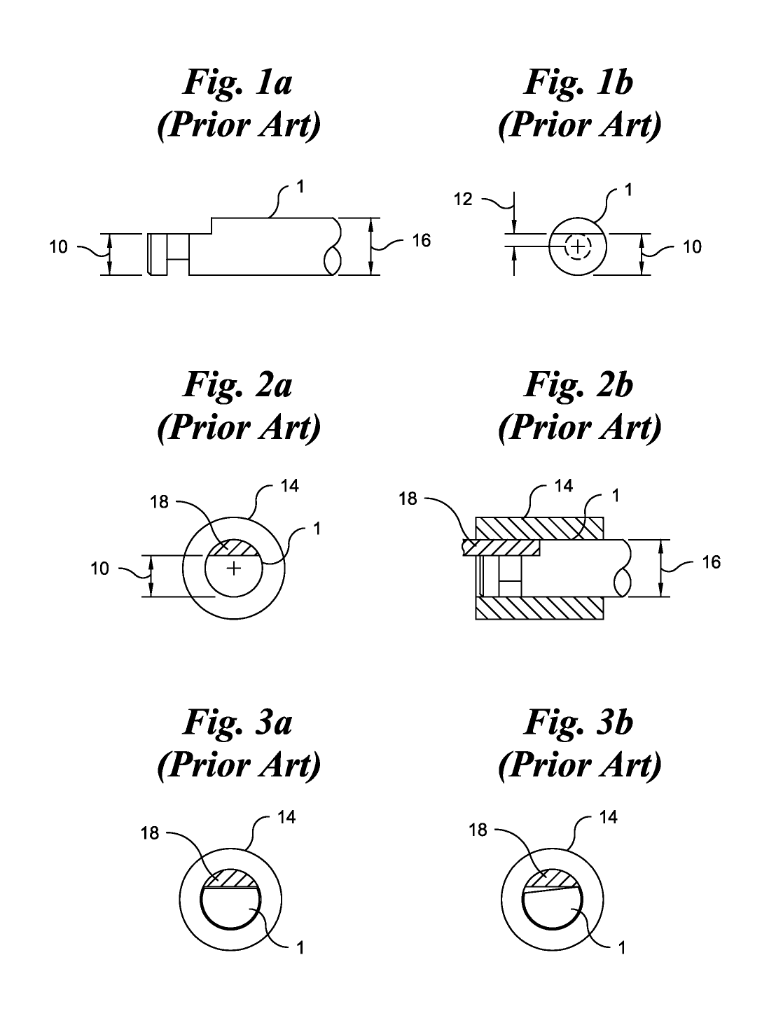

FIG. 1a shows an angled shaft 1 of the prior art, as provided for rotating instruments. Seen here is an end surface, which is used for force transmission. The end surface has a height 10 of approximately 1.8 mm. To achieve an ideal force transmission and to allow use in standard devices, the angled shaft 1 is constructed in such a way that the total diameter 16 of the angled shaft 1 equals approximately 2.35 mm. As shown in FIG. 1b, the distance 12 between the center of the end surface and the outer edge equals 0.625 mm at the smallest point.

FIGS. 2a and 2b show a driver pin 18 in an angled piece 14, in which the angled shaft 1 can be inserted. The driver pin 18 is here constructed as a counterpiece to the angled shaft 1 and its end surface with height 10 and naturally has a clearance fit, so that an air gap is produced between the two surfaces. The greater the play, the easier the instrument can be inserted, but the greater the tendency for jamming. Not shown is a lock, which holds the angled shaft 1 in its position in the angled piece 14. The edge of the driver pin 18 has a construction lying straight with the angled shaft.

FIG. 3a shows an end view of the connection of the angled shaft 1 and the angled piece 14 with a driver pin 18 according to the prior art, in an unloaded state. Here, the edge of driver pin 18 is straight and contacts the angled shaft 1 and its upper end surface with its entire surface. Here, the typical linear contact is represented in FIG. 3b under a load, which can lead to damage at the outer edge of the angled shaft 1.

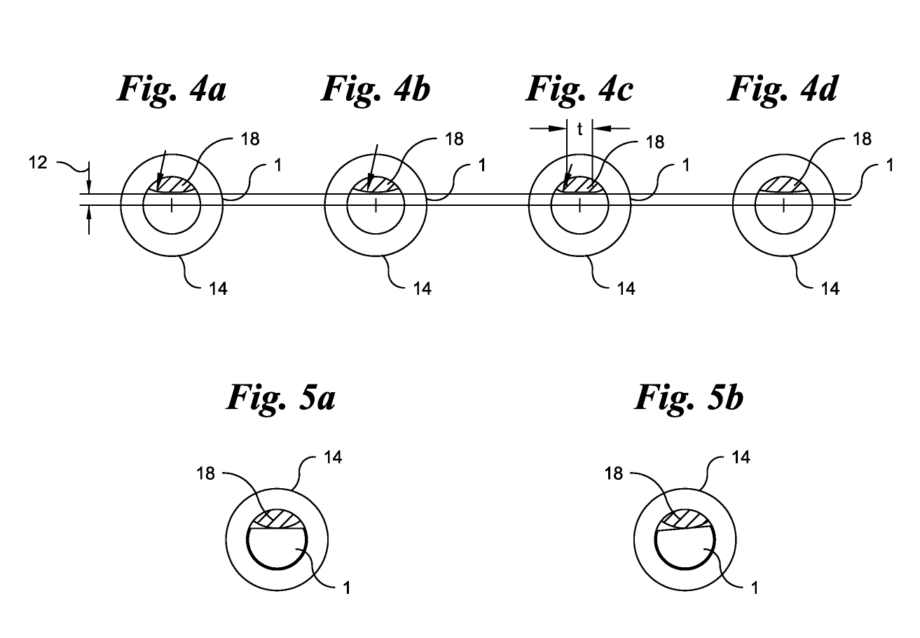

FIGS. 4a to 4d show end views of a driver pin 18 in an angled piece 14 according to embodiments of the invention. Shown are several possibilities for the configuration of the geometry of the driver pin, so that the contact surface for the angled shaft 1 and the end surface of the instrument is always formed in a planar contact position. The distance 12 between the center of the end surface and the outer edge equals approximately 0.625 mm. It can be seen clearly that the contact edge of the driver pin 18 in the angled piece 14 is slightly curved. By this curvature of the edge, good durability and stability of the dental instrument are achieved, because this curvature allows the planar contact to be formed independently of angle. It always leads to a planar contact without linear contact. Here, the curvature of the edge of the driver pin 18 can have different magnitudes of curvature and can optionally have section(s) t which are even straight, as shown, for example, in FIG. 4c.

In FIG. 5a, an unloaded connection of the angled shaft 1 and the angled piece 14 is shown in end view with a driver pin 18 according to an embodiment of the invention. An embodiment according to the invention is shown, in which a planar force transmission is realized with the help of a constant radius. In FIG. 5b the planar contact is represented under torsion loading, which is formed at a contact between the surface of the angled shaft 1 and the curvature of the driver pin 18.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An angled shaft receptacle for operating rotating instruments having an angled shaft, the angled shaft receptacle comprising a driver pin, wherein the driver pin is connectable to the angled shaft for operation by a planar contact, and wherein the planar contact, which is formed by the driver with the angled shaft, lies in a range defined by Hooke's Law.

2. The angled shaft receptacle according to claim 1, wherein the angled shaft receptacle is operable by a motor or manually for operation of the rotating instrument.

3. The angled shaft receptacle according to claim 1, wherein the driver pin has a constant radius at a force-transmitting surface.

4. The angled shaft receptacle according to claim 1, wherein the driver pin has a variable radius at a force-transmitting surface.

5. The angled shaft receptacle according to claim 1, wherein the driver pin has a combination of surfaces and radii of variable type on a force-transmitting surface.

6. The angled shaft receptacle according to claim 1, wherein a supporting thrust bearing is present in the angled shaft receptacle on a side opposite the driver pin.

7. The angled shaft receptacle according to claim 1, wherein the rotating instrument is a dental instrument.
